(19) United States
(12) Patent Application Publication
(10) Pub. No.: US 2017/0303480 A1
(43) Pub. Date: Oct. 26, 2017

(54) Water Containment Device

(71) Applicant: Lalit Kumar, San Jose, CA (US)

(72) Inventor: Lalit Kumar, San Jose, CA (US)

(21) Appl. No.: 15/491,007

(22) Filed: Apr. 19, 2017

Related U.S. Application Data
(60) Provisional application No. 62/325,161, filed on Apr. 20, 2016.

(51) Int. Cl. A01G 27/00

(52) U.S. Cl. CPC A01G 27/00

(57) ABSTRACT

A water containment device. The water containment device provides a bendable strip for containing water around plants. The strip includes interlocking slots or other fasteners for creating a closed loop or connecting with a second similar strip. The strip also includes teeth on a bottom side that are configured to penetrate and engage a ground surface to keep the strip in an upright orientation. Once secured around a plant, the strip prevents water from leaving from a close proximity from the surface or the top soil around the plant.

### CROSS REFERENCE TO RELATED APPLICATION

This application claims the benefit of U.S. Provisional Application No. 62/325,161 filed on Apr. 20, 2016. The above identified patent application is herein incorporated by reference in its entirety to provide continuity of disclosure.

### BACKGROUND OF THE INVENTION

### Field of the Invention

The present invention relates to a water containment device. More specifically, the present invention provides a water containment device comprising a bendable strip for containing water around plants. The strip comprises serrated, saw-like teeth disposed along a bottom portion of the strip that are adapted to allow a user to dig the strip into the ground without assistance from another tool.

Some common types of ground strips are generally used for separating landscaped areas from non-landscaped areas, preventing the encroachment of grass and weeds. These conventional edging strips typically include integrally molded stakes capable of linking with other stakes or strips in order to create a barrier restricting unwanted encroachment into the separated area. However, one of the shortcomings of these devices includes the inability to hold water in close proximity to a selected plant and prevent water from flowing away.

Devices have been disclosed in the known art that relate to edging strips that provide water containment. These include devices that have been patented and published in patent application publications. These devices in the known art have several known drawbacks. For example, using one of these conventional edging strips in close proximity to a plant creates a risk that the plant will have inhibited growth because the edging strips are not configured to retain water and are adapted to separate vegetation growth. Thus, an additional shortcoming is that these devices fail to provide a strip comprising a plastic strip for containing water around plants.

In light of the devices disclosed in the known art, it is submitted that the present invention substantially diverges in design elements from the devices in the known art and consequently it is clear that there is a need in the art for an improvement to existing water containment devices. In this regard the instant invention substantially fulfills these needs.

### SUMMARY OF THE INVENTION

In view of the foregoing disadvantages inherent in the known types of water containment device now present in the art, the present invention provides a new water containment device wherein the same can be utilized for providing convenience for the user when gardening or tending plants.

It is therefore an object of the present invention to provide a new and improved water containment device for water containment around selected plants. In particular, the present invention assists the aforementioned objective by providing an impermeable, bendable plastic strip configured to form a closed loop that surrounds a selected plant

It is another object of the present invention to provide a water containment device having teeth disposed along a bottom side of the strip that are in a serrated configuration and adapted to allow a user to dig the strip into the ground without assistance from another tool.

Another object of the present invention is to provide a water containment device having a moisture meter to indicate and track the amount of moisture in the surrounding ground.

Another object of the present invention is to provide a water containment device that may be readily fabricated from materials that permit relative economy and are commensurate with durability.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of the water containment device.

FIG. 2 shows a perspective view of the water containment device in one use with a plant.

FIG. 3 shows a perspective view of another embodiment of the present invention forming a closed loop configuration.

FIG. 4 shows a flowchart of one method of use of the water containment device.

### DETAILED DESCRIPTION OF THE INVENTION

Reference is made herein to the attached drawings. Like reference numerals are used throughout the drawings to depict like or similar elements of the water containment device. For the purposes of presenting a brief and clear description of the present invention, the preferred embodiment will be discussed as used for containing water in close proximity to a selected plant. The figures are intended for representative purposes only and should not be considered to be limiting in any respect.

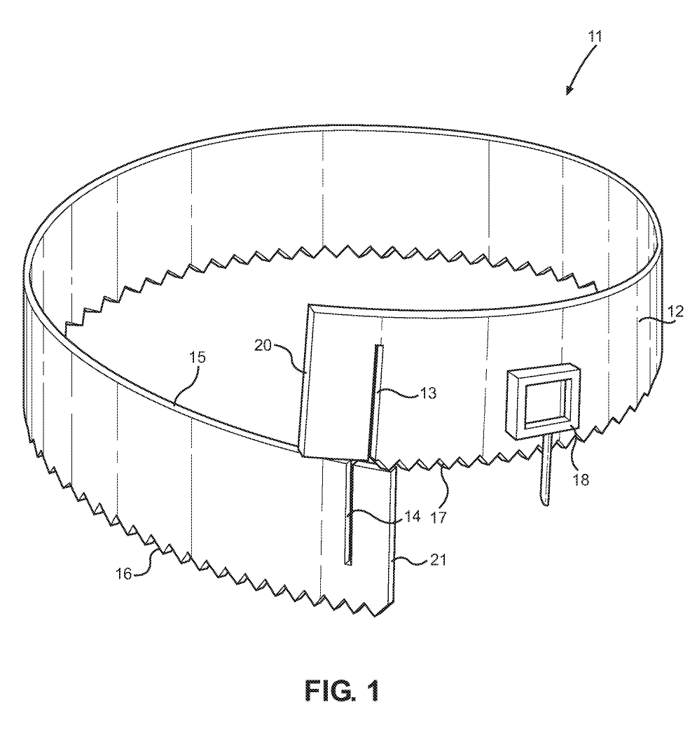

Referring to FIG. 1, there is shown a perspective view of the water containment device. The water containment device 11 provides a flexible strip 12 for containing water around one or more plants. The strip 12 includes one or more interlocking slots 13, 14 disposed on a top side 15 and a bottom side 16, wherein the top side 15 is opposite the bottom side 16. In the shown embodiment, the strip 12 is generally planar having a first end 20 and an opposing second end 21, wherein each end 20, 21 is configured to be attached to the opposing end to form a closed loop or to be attached to a substantially similar strip.

The one or more interlocking slots 13, 14 comprise a first slot 13 disposed on the first end 20 of the strip 12 and a second slot 14 disposed on the second end 21 of the strip 12. In the shown embodiment, the first slot 13 includes an open end disposed on the bottom side 16 and the second slot 14 includes an open end disposed on the top side 15, wherein each of the slots 13, 14 are vertically oriented, dimensioned and configured to interlock with the other slot. When the vertical slots 13, 14 are interlocked, the strip 12 maintains a continuous closed loop configuration. In addition, tape or other fasteners may be applied over the ends 20, 21 to further secure the ends 20, 21 to each other. In this way, the slots 13, 14 are adapted to be interlocked such that the ends 20, 21 of the strip 12 uniformly overlaps therewith. However, in alternative embodiments, the open end of each of the slots 13, 14 may be disposed anywhere along the strip 12 and oriented in any direction, such that the slots 13, 14 may be interlocked.

In the shown embodiment, the bottom side 16 includes teeth 17 that are serrated and configured to engage a ground surface to maintain the strip 12 in an upright position. In the shown embodiment, the teeth 17 are represented as triangular protruding members. Further, the teeth allow penetration into the ground without the assistance of other tools, such as shovels and the like. A moisture meter 18 is disposed on the strip 12, wherein the moisture meter 18 is configured to detect and display the moisture content of the surrounding ground surface. In the shown embodiment, the moisture meter 18 includes a probe that extend past the bottom side 16 of the strip 12. In alternative embodiments, the moisture meter 18 may be disposed anywhere along the strip 12. In one embodiment, the moisture meter 18 is disposed on an interior of the closed strip 12, such that ground saturation within the enclosed area can be detected.

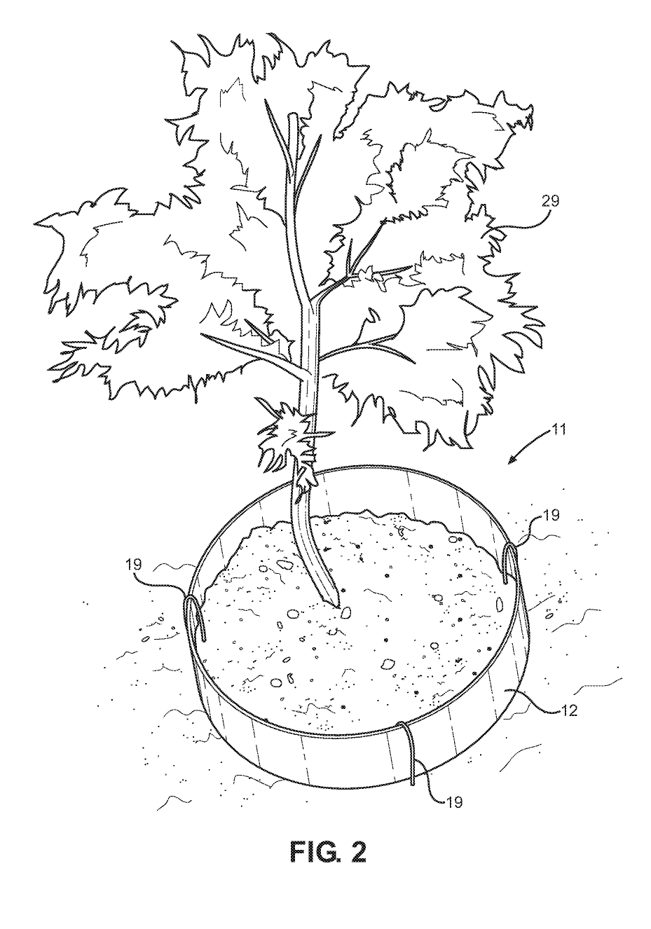

Referring to FIG. 2, there is shown a perspective view of the water containment device in one use with a plant. The water containment device 11 is configured to be positioned around a selected plant 29 in a closed loop, such that the strip 12 is forms a perimeter around the plant 29. The teeth allow a user to insert the strip into the ground at some depth. The strip 12 provides an impermeable barrier that extends at least some distance into the ground to collect and retain water positioned within the perimeter formed by the closed loop configuration of the strip 12. Further, one or more retention stakes 19 are configured to removably secure the strip 12 to the ground and may be positioned over the strip 12 at certain intervals. In the shown embodiment, the retention stakes 19 are U-shaped and inserted into the ground wherein the strip 12 is secured therebetween. Once installed, the water containment device 11 contains water in close proximity to the plant 29 and prevents water from flowing away from the plant 29.

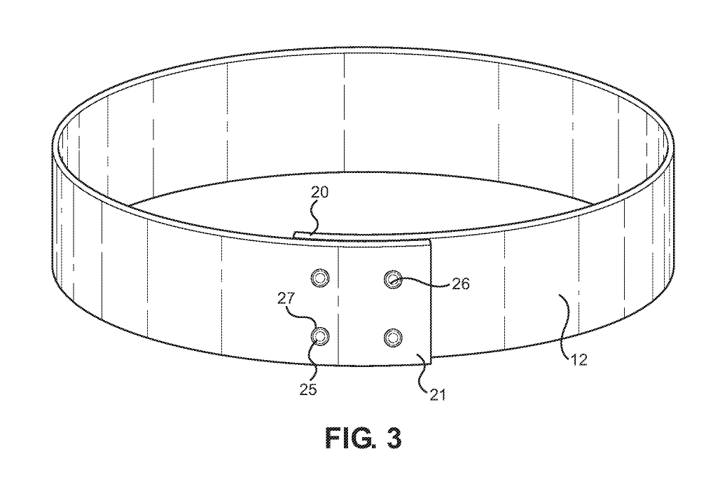

Referring to FIG. 3, there is shown a perspective view of another embodiment of the present invention forming a closed loop configuration. In the shown embodiment, the first end 20 of the strip 12 includes one or more apertures 25 that correspond to one or more apertures 26 disposed on the second end 21. The apertures 25, 26 are configured to receive a fastener 27 that secures the first and second ends 20, 21 together. In the shown embodiment, the apertures 25, 26 are arranged in a two by two matrix. However, in alternative embodiments, the apertures 25, 26 may be positioned in any arrangement. These corresponding apertures 25, 26 and fasteners 27 allow the strip 12 to interlock with itself to form a closed loop, or to interlock with a substantially similar strip. In this way, a user may install the device in the ground surrounding a plant or tree to contain water in close proximity to the plant or tree and prevent water from flowing away. Additionally, the flexibility of the strip enables the perimeter of the closed loop to have curved and irregular shapes as needed. This is particularly useful in areas having limited access or fixed objects, such as walls, roads, and plant roots that prevent insertion of the strip in those areas. In the shown embodiment, the strip comprises a uniform width between the top side and the bottom side and a uniform thickness.

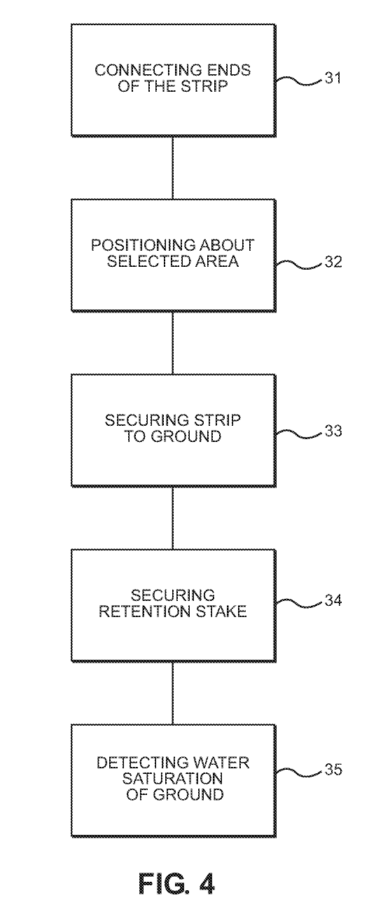

Referring to FIG. 4, there is shown a flowchart of one method of use of the water containment device. The method of installing and using the water containment device comprises connecting 31 the one or more interlocking slots to form a closed strip; positioning 32 the closed strip about a selected area; securing 33 the closed strip to a ground surface via a bottom edge of the strip, the bottom edge comprising serrated teeth configured to engage the ground surface to maintain the strip in an upright position; securing 34 the closed strip to the to a ground surface via a retention stake comprising a fastener disposed on a first end configured to engage the top edge of the strip and a tip disposed on a second end configured to secure the retention stake to a ground surface; and detecting 35 a water saturation of the ground surface via a moisture meter disposed on the strip. In one embodiment, the water saturation of the ground surface inside the strip is detected via the moisture meter.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A water containment device, comprising:
a strip having one or more interlocking slots disposed on a top side and a bottom side, wherein the top side opposes the bottom side;
the one or more interlocking slots comprise a first slot disposed on a first end of the strip and a second slot disposed on a second end of the strip;
wherein the first slot is disposed on an opposing side from the second slot, wherein the first slot is configured to interlock with the second slot.

2) The water containment device of claim 1, wherein:
the bottom side comprises serrated teeth configured to engage a ground surface and maintain the strip in an upright position.

3) The water containment device of claim 1, wherein:
the strip has a uniform width between the top side and the bottom side.

4) The water containment device of claim 1, wherein:
the first slot is disposed on the top side and the second slot is disposed on the bottom side.

5) The water containment device of claim 1, wherein:
the strip comprises a moisture meter configured to detect a water saturation of a surrounding ground area.

6) The water containment device of claim 1, wherein:
the strip a water impermeable and flexible plastic material.

7) The water containment device of claim 1, further comprising:
a retention stake comprising a fastener disposed on a first end configured to engage the top edge of the strip and a tip disposed on a second end configured to secure the retention stake to a ground area.

8) A system and method of containing water with a water containment device, comprising;
a strip having one or more interlocking slots disposed on a top side and a bottom side, wherein the top side opposes the bottom side;
the one or more interlocking slots comprise a first slot disposed on a first end of the strip and a second slot disposed on a second end of the strip;
wherein the first slot is disposed on an opposing side from the second slot, wherein the first slot is configured to interlock with the second slot; wherein the method comprises:
connecting the one or more interlocking slots to form a closed strip;
positioning the closed strip about a selected area;
securing the closed strip to a ground surface via a bottom edge of the strip, the bottom edge comprising serrated teeth configured to engage the ground surface to maintain the strip in an upright position.

9) The system and method of containing water with a water containment device of claim 8, further comprising:
securing the closed strip to the to a ground surface via a retention stake comprising a fastener disposed on a first end configured to engage the top edge of the strip and a stake disposed on a second end configured to secure the retention stake to a ground surface.

10) The system and method of containing water with a water containment device of claim 9, further comprising:
detecting a water saturation of the ground surface via a moisture meter disposed on the strip.
